(19) United States
(12) Patent Application Publication
(10) Pub. No.: US 2025/0008159 A1
(43) Pub. Date: Jan. 2, 2025

(54) ARITHMETIC CODING WITH SPATIAL TUNING

(71) Applicant: Nokia Technologies Oy, Espoo (FI)

(72) Inventors: Jani LAINEMA, Tampere (FI); Alireza AMINLOU, Tampere (FI)

(21) Appl. No.: 18/346,143

(22) Filed: Jun. 30, 2023

(51) Int. Cl. H04N 19/70; H04N 19/169

(52) U.S. Cl. CPC H04N 19/70; H04N 19/1883

(57) ABSTRACT

An apparatus configured to: determine to encode or decode a first coding tree unit, wherein a second coding tree unit is at least partially different from the first coding tree unit, wherein the second coding tree unit comprises a previously encoded or decoded coding tree unit; in response to determining to encode or decode the first coding tree unit, determine at least one stored syntax element value based, at least partially, on a location of the first coding tree unit; and update at least one state variable of the apparatus based, at least partially, on the at least one stored syntax element value.

### TECHNICAL FIELD

The example and non-limiting embodiments relate generally to digital video coding and/or decoding and, more particularly, to updating of state variables of a codec used for the coding and/or decoding.

### BACKGROUND

It is known, in coding and decoding, to use an arithmetic coder to compress and/or decompress syntax elements based on probability estimates for the syntax elements.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: determine to encode or decode a first coding tree unit, wherein a second coding tree unit is at least partially different from the first coding tree unit, wherein the second coding tree unit comprises a previously encoded or decoded coding tree unit; in response to determining to encode or decode the first coding tree unit, determine at least one stored syntax element value based, at least partially, on a location of the first coding tree unit; and update at least one state variable of the apparatus based, at least partially, on the at least one stored syntax element value.

In accordance with one aspect, a method comprising: determining, with a user equipment, to encode or decode a first coding tree unit, wherein a second coding tree unit is at least partially different from the first coding tree unit, wherein the second coding tree unit comprises a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

In accordance with one aspect, an apparatus comprising means for: determining to encode or decode a first coding tree unit, wherein a second coding tree unit is at least partially different from the first coding tree unit, wherein the second coding tree unit comprises a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

In accordance with one aspect, a non-transitory computer-readable medium comprising program instructions stored thereon for performing at least the following: determining to encode or decode a first coding tree unit, wherein a second coding tree unit is at least partially different from the first coding tree unit, wherein the second coding tree unit comprises a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the example embodiments may be practiced;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein; and

FIG. 7 is a flowchart illustrating steps as described herein.

### DETAILED DESCRIPTION OF EMBODIMENTS

The following abbreviations that may be found in the specification and/or the drawing figures are defined as follows:
3GPP third generation partnership project
4G fourth generation
5G fifth generation
5GC 5G core network
AR augmented reality
AVC advanced video coding (ITU-T H.264 video coding standard)
BCW bi-prediction with CU-level weight
CABAC context adaptive binary arithmetic coder
CCCM convolutional cross-component model
CCRM cross-component residual model/cross-component reconstruction model
CDMA code division multiple access
CIIP combined inter and intra prediction
CPU central processing unit
CRAN cloud radio access network
CTU coding tree unit
CU coding unit
DCT discrete cosine transform
DPBB decoded picture buffer
DST discrete sine transform
ECM enhanced compression model (JVET's exploratory video codec)
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDMA frequency division multiple access
gNB (or gNodeB) base station for 5G/NR, i.e., a node providing NR user plane and control plane protocol terminations towards the UE, and connected via the NG interface to the 5GC
GPU graphical processing unit
GSM global systems for mobile communications
HEVC high efficiency video coding (ITU-T H.265 video coding standard)
HMD head-mounted display
IBC intra block copying
IEEE Institute of Electrical and Electronics Engineers
IMD integrated messaging device
IMS instant messaging service
IoT Internet of Things
LCU largest coding unit
LIC local illumination compensation
LTE long term evolution
MMS multimedia messaging service
MPEG-I Moving Picture Experts Group immersive codec family
MR mixed reality
ng or NG new generation
ng-eNB or NG-eNB new generation eNB
NR new radio
N/W or NW network
O-RAN open radio access network
PC personal computer
PDA personal digital assistant
PU prediction unit
QP quantization parameter
RGB red, green, blue
SMS short messaging service
SNR signal-to-noise ratio
TCP-IP transmission control protocol-internet protocol
TDMA time division multiple access
TU transform unit
UE user equipment (e.g., a wireless, typically mobile device)
UMTS universal mobile telecommunications system
USB universal serial bus
VR virtual reality
WLAN wireless local area network
VNR virtualized network function
VVC versatile video coding (ITU-T H.266 video coding standard)
WP weighted prediction
YUV/YCbCr a color model based on one luminance and two chrominance/color difference channels (typically used in many video coding applications)

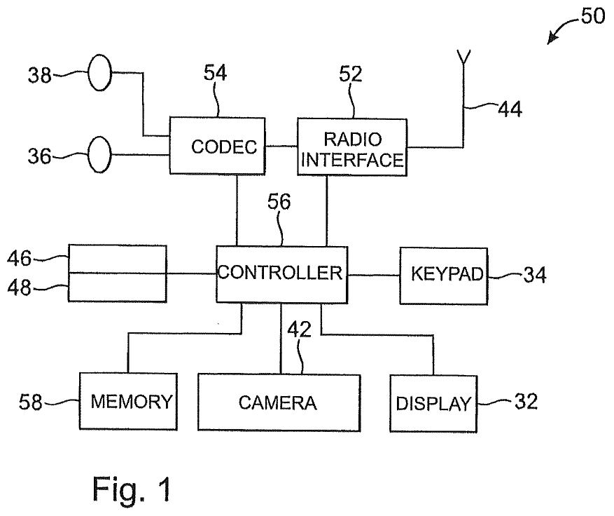

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that example embodiments of the present disclosure may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in example embodiments of the present disclosure may be any one of: an earpiece, speaker, or an analogue audio or digital audio output connection. The electronic device 50 may also comprise a battery (or in other example embodiments of the present disclosure the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other example embodiments of the present disclosure the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in example embodiments of the present disclosure may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

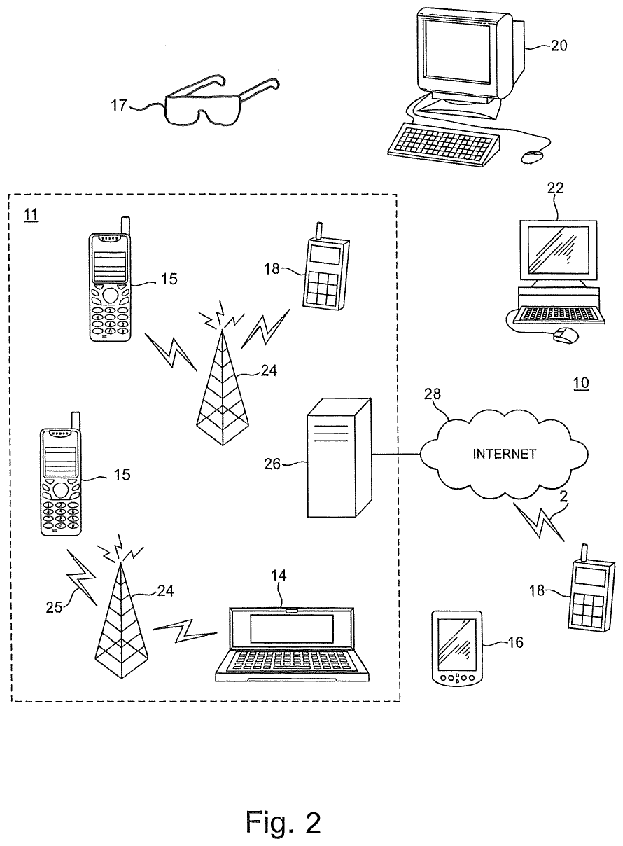

With respect to FIG. 2, an example of a system within which example embodiments of the present disclosure can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G network etc.), a wireless local area network (WLAN) such as defined by any of the IEEE 802.x standards, a BLUETOOTH™ personal area network, an Ethernet local area network, a token ring local area network, a wide area network, and/or the Internet. A wireless network may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors and memories, and also such virtualized entities create technical effects.

It may also be noted that operations of example embodiments of the present disclosure may be carried out by a plurality of cooperating devices (e.g. cRAN).

The system 10 may include both wired and wireless communication devices and/or electronic devices suitable for implementing example embodiments of the present disclosure.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The example embodiments of the present disclosure may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The example embodiments of the present disclosure may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, access point, access node, other node, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH™, IEEE 802.11, 3GPP Narrowband IoT and any similar wireless communication technology. A communications device involved in implementing various example embodiments of the present disclosure may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced one suitable but non-limiting technical context for the practice of the example embodiments of the present disclosure, example embodiments will now be described with greater specificity.

Features as described herein may generally relate to coding and decoding of digital video material. A video codec consists of an encoder that transforms the input video into a compressed representation suited for storage/transmission and a decoder that can decompress the compressed video representation back into a viewable form. Typically, the encoder discards some information in the original video sequence to be able to represent the video in a more compact form (that is, at a lower bitrate).

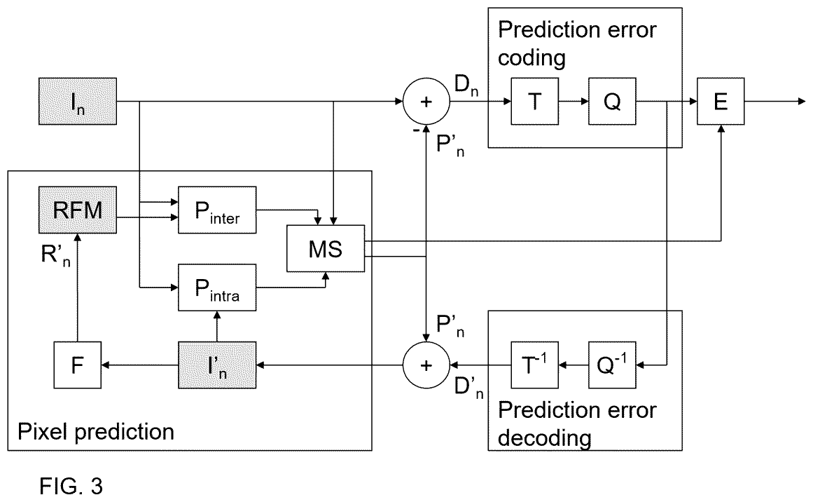

Typical hybrid video codecs, such as H.264/AVC, H.265/HEVC and H.266/VVC, encode the video information in two phases. Firstly, pixel values in a certain picture area (or “block”) may be predicted for example by motion compensation means (i.e. finding and indicating an area in one of the previously coded pictures that corresponds closely to the block being coded) or by spatial means (i.e. using the pixel values around the block to be coded in a specified manner). Secondly, the prediction error (i.e. the difference between the predicted block of pixels and the original block of pixels) may be coded. This may typically be done by transforming the difference in pixel values using a specified transform (e.g. Discrete Cosine Transform (DCT) or a variant of it), quantizing the resulting transform coefficients, and entropy coding the quantized coefficients. By varying the fidelity of the quantization process, the encoder may control the balance between the accuracy of the pixel representation (i.e. picture quality) and the size of the resulting coded video representation (e.g. file size or transmission bitrate). An example of the encoding process is illustrated in FIG. 3.

In the example of FIG. 3, a video encoding system is illustrated. An image to be encoded (Iₙ) may be provided, along with a predicted representation of an image block (P′ₙ), for determining the prediction error signal (Dₙ). Prediction error coding may be performed on the prediction error signal (Dₙ), comprising transform (T) and quantization (Q). Entropy encoding (E) may be performed on the output of the prediction error coding; the entropy encoded prediction error may be output.

Prediction error decoding may be performed on the output of the prediction error coding, comprising inverse transform (T⁻¹) and inverse quantization (Q⁻¹). The result of the prediction error decoding, the reconstructed prediction error signal (D′ₙ), may be provided for combination with a predicted representation of an image block (P′ₙ); the combination may be provided for pixel prediction. A preliminary reconstructed image (I′ₙ) may be provided for filtering (F) to produce a final reconstructed image (R′ₙ), which may be provided for reference frame memory. The output of the reference frame memory and the image to be encoded (Iₙ) may be provided for inter prediction (Pᵢₙₜₑᵣ). The preliminary reconstructed image (I′ₙ) may also be provided for intra prediction (Pᵢₙₜᵣₐ). The image to be encoded (Iₙ), the output of inter prediction (Pᵢₙₜₑᵣ), and the output of intra prediction (Pᵢₙₜᵣₐ) may be provided for mode selection (MS). The output of mode selection (MS) may be provided as a predicted representation of an image block (P′ₙ) and/or to entropy encoding (E).

In some video codecs, such as H.265/HEVC and H.266/VVC, the video pictures may be divided into coding units (CU) covering the area of the picture. A CU may consist of one or more prediction units (PU) defining the prediction process for the samples within the CU and one or more transform units (TU) defining the prediction error coding process for the samples in the said CU. Typically, a CU consists of a rectangular block of samples with a size selectable from a predefined set of possible CU sizes. A CU with the maximum allowed size may typically be named as LCU (largest coding unit) or CTU (coding tree unit), and the video picture may be divided into non-overlapping CTUs. A CTU may be further split into a combination of smaller CUs, e.g. by recursively splitting the CTU and resultant CUs. Each resulting CU typically may have at least one PU and at least one TU associated with it. Each PU and TU may be further split into smaller PUs and TUs to increase granularity of the prediction and prediction error coding processes, respectively.

Each PU has prediction information associated with it defining what kind of a prediction is to be applied for the pixels within that PU (e.g. motion vector information for inter predicted Pus, and intra prediction directionality information for intra predicted PUs). Similarly, each TU may be associated with information describing the prediction error decoding process for the samples within the TU (including e.g. DCT coefficient information). It may typically be signaled at CU level whether prediction error coding is applied or not for each CU. In the case there is no prediction error residual associated with the CU, it may be considered that there are no TUs for said CU. The division of the image into CUs, and division of CUs into PUs and TUs, may typically be signaled in the bitstream, allowing the decoder to reproduce the intended structure of these units.

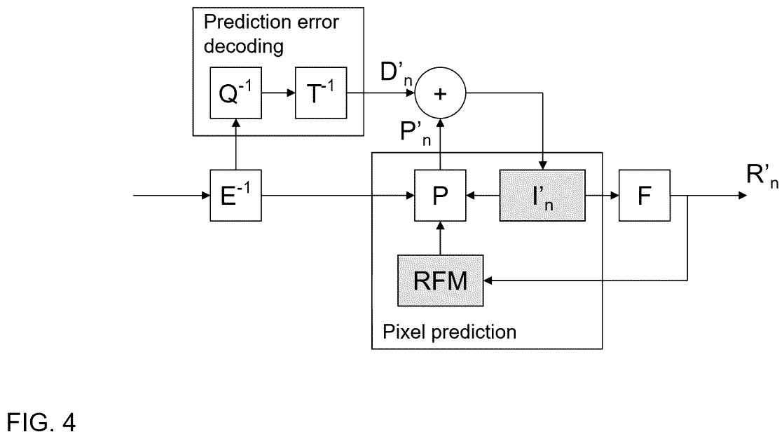

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder may sum up the prediction and prediction error signals (pixel values) to form the output video frame. The decoder (and encoder) may also apply additional filtering means to improve the quality of the output video before passing it for display and/or storing it as prediction reference for the forthcoming frames in the video sequence. The decoding process is illustrated in FIG. 4.

In the example of FIG. 4, a video decoding system is illustrated. The encoded video may be provided for entropy decoding (E⁻¹). The entropy decoded content may be provided for prediction error decoding and pixel prediction. Prediction error decoding may comprise inverse quantization (Q⁻¹) and inverse transform (T⁻¹), and may result in a reconstructed prediction error signal (D′ₙ). The reconstructed prediction error signal (D′ₙ) may be combined with a predicted representation of an image block (P′ₙ) and provided to generate a preliminary reconstructed image (I′ₙ). The preliminary reconstructed image (I′ₙ) may be provided for filtering (F), resulting in a final reconstructed image (R′ₙ).

Pixel prediction may comprise prediction (P) (either inter or intra), which may result in a predicted representation of an image block (P′ₙ). The predicted representation of an image block (P′ₙ) may also be based on reference frame memory (RFM), which may be based on the final reconstructed image (R′ₙ), and the preliminary reconstructed image (I′ₙ).

Instead, or in addition to approaches utilizing sample value prediction and transform coding for indicating the coded sample values, a color palette-based coding may be used. Palette based coding refers to a family of approaches for which a palette (i.e. a set of colors and associated indexes) is defined, and the value for each sample within a coding unit is expressed by indicating its index in the palette. Palette based coding can typically achieve good coding efficiency in coding units with a relatively small number of colors (e.g. image areas which are representing computer screen content, like text or simple graphics).

In order to improve the coding efficiency of palette coding, different kinds of palette index prediction approaches may be utilized, or the palette indexes may be run-length coded to be able to represent larger homogenous image areas efficiently. Also, in the case the CU contains sample values that are not recurring within the CU, escape coding may be utilized. Escape coded samples are transmitted without referring to any of the palette indexes. Instead, their values are indicated individually for each escape coded sample.

In typical video codecs the motion information may be indicated with motion vectors associated with each motion compensated image block. Each of these motion vectors represents the displacement of the image block in the picture to be coded (in the encoder side) or decoded (in the decoder side), and the prediction source block in one of the previously coded or decoded pictures. To represent motion vectors efficiently, those are typically coded differentially with respect to block specific predicted motion vectors.

In typical video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor.

In addition to predicting the motion vector values, the reference index of previously coded/decoded picture may be predicted. The reference index is typically predicted from adjacent blocks and/or co-located blocks in temporal reference picture. Moreover, typical high efficiency video codecs may employ an additional motion information coding/decoding mechanism, often called merging or merge mode, where all the motion field information, which includes motion vector and corresponding reference picture index for each available reference picture list, is predicted and used without any modification/correction.

Similarly, predicting the motion field information may be carried out using the motion field information of adjacent blocks and/or co-located blocks in temporal reference pictures, and the used motion field information may be signaled among a list of motion field candidate list filled with motion field information of available adjacent/co-located blocks.

Typically, video codecs support motion compensated prediction from at least one source image (uni-prediction) and two sources (bi-prediction). In the case of uni-prediction a single motion vector is applied, whereas in the case of bi-prediction two motion vectors are determined and the motion compensated predictions from two sources are combined to create the final sample prediction. In the case of weighted prediction the relative weights of the two predictions may be adjusted, or a signaled offset may be added to the prediction signal.

In addition to applying motion compensation for inter picture prediction, a similar approach may be applied to intra picture prediction. In this case, the displacement vector indicates where, from the same picture, a block of samples may be copied to form a prediction of the block to be coded or decoded. This kind of intra block copying (IBC) method(s) may improve the coding efficiency substantially in the presence of repeating structures within the frame, such as text or other graphics.

In typical video codecs, the prediction residual after motion compensation or intra prediction may first be transformed with a transform kernel (like DCT) and then coded. The reason for this is that, often, there still exists some correlation among the residual and transform may, in many cases, help reduce this correlation and provide more efficient coding.

Typical video encoders utilize Lagrangian cost functions to find optimal coding modes (e.g. the desired Macroblock mode and associated motion vectors). This kind of cost function uses a weighting factor λ to tie together the (exact or estimated) image distortion due to lossy coding methods and the (exact or estimated) amount of information that is required to represent the pixel values in an image area:

$$C = D + λ R \qquad ( Eq . 1 )$$

where C is the Lagrangian cost to be minimized, D is the image distortion (e.g. Mean Squared Error) with the mode and motion vectors considered, and R is the number of bits needed to represent the required data to reconstruct the image block in the decoder (including the amount of data to represent the candidate motion vectors).

Scalable video coding refers to coding structure where one bitstream may contain multiple representations of the content at different bitrates, resolutions or frame rates. In these cases, the receiver may extract the desired representation depending on its characteristics (e.g. resolution that matches best the display device). Alternatively, a server or a network element may extract the portions of the bitstream to be transmitted to the receiver depending on, for example, the network characteristics or processing capabilities of the receiver.

A scalable bitstream typically consists of a “base layer” providing the lowest quality video available and one or more “enhancement layers” that enhance the video quality when received and decoded together with the lower layers. To improve coding efficiency for the enhancement layers, the coded representation of that layer typically depends on the lower layers. For example, the motion and mode information of the enhancement layer may be predicted from lower layers. Similarly, the pixel data of the lower layers may be used to create prediction for the enhancement layer.

A scalable video codec for quality scalability (also known as Signal-to-Noise ratio or SNR) and/or spatial scalability may be implemented as follows. For a base layer, a conventional non-scalable video encoder and decoder may be used. The reconstructed/decoded pictures of the base layer may be included in the reference picture buffer for an enhancement layer. In H.264/AVC, H.265/HEVC, and similar codecs using reference picture list(s) for inter prediction, the base layer decoded pictures may be inserted into a reference picture list(s) for coding/decoding of an enhancement layer picture, similarly to the decoded reference pictures of the enhancement layer. Consequently, the encoder may choose a base-layer reference picture as inter prediction reference and indicate its use, typically with a reference picture index in the coded bitstream. The decoder may decode from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability, examples of other scalability modes include: spatial scalability-enhancement layer pictures are coded at a higher resolution than the base layer pictures; bit-depth scalability-enhancement layer pictures are coded at higher bit-depth (e.g. 10 or 12 bits) than base layer pictures (e.g. 8 bits); and chroma format scalability-enhancement layer pictures provide higher fidelity in chroma (e.g. coded in 4:4:4 chroma format) than base layer pictures (e.g. 4:2:0 format). In these scalability cases, base layer information may be used to code enhancement layer to minimize the additional bitrate overhead.

Scalability may be enabled in two basic ways: either by introducing new coding modes for performing prediction of pixel values or syntax from lower layers of the scalable representation; or by placing the lower layer pictures to the reference picture buffer (decoded picture buffer, DPB) of the higher layer. The first approach is more flexible, and thus can provide better coding efficiency in most cases. However, the second, reference frame-based scalability approach may be implemented very efficiently with minimal changes to single layer codecs, while still achieving a majority of the coding efficiency gains available. Essentially, a reference frame-based scalability codec may be implemented by utilizing the same hardware or software implementation for all the layers, and just taking care of the DPB management by external means.

To be able to utilize parallel processing, images may be split into independently codable and decodable image segments (e.g. slices or tiles). Slices typically refer to image segments constructed of a certain number of basic coding units that are processed in default coding or decoding order, while tiles typically refer to image segments that have been defined as rectangular image regions that are processed, at least to some extent, as individual frames.

Typically, video is encoded in a YUV or YCbCr color space, as that is found to reflect some characteristics of the human visual system, and allows use of a lower quality representation for Cb and Cr channels, as human perception is less sensitive to the chrominance fidelity those channels represent.

Typical video codecs, such as H.265/HEVC (see, e.g., ITU-T recommendation H.265: “High efficiency video coding”, https://www.itu.int/rec/T-REC-H.265) and H.266/VVC (see, e.g., ITU-T recommendation H.266: “Versatile video coding”, http://www.itu.int/rec/T-REC-H.266) standards use context adaptive binary arithmetic coder (CABAC) for the purpose of compressing and decompressing different syntax elements efficiently. Being a binary arithmetic coder, CABAC encodes and decodes syntax elements of size 1 bit. An alternative is to use non-binary arithmetic coders, where encoded and decoded symbols can represent syntax elements with more than one bit of information. The following example embodiments are applicable to both binary and non-binary arithmetic coders, although examples are given for the case of binary arithmetic coding for simplicity.

In the case of context adaptive arithmetic coding, each syntax element has an estimate of probabilities for its possible values. Sometimes the estimated probability of a syntax element may depend on other data available during the coding process. For example, it may depend on the coding mode of a coding unit. Thus, it has been found beneficial to define multiple “contexts” for some syntax elements to be able to estimate the probability of that syntax element more accurately considering the “context”, or the environment, where the syntax element appears. As a simple example, a syntax element may have two contexts, one if the syntax element appears in an Intra coded block and another if the syntax element appears in an Inter coded block.

The efficiency of the arithmetic coder depends heavily on the accuracy of the probability estimates generated for the contexts. For example, the H.266 standard estimates the probabilities of syntax element being 0 or 1 using two estimators with different characteristics and calculates the active probability for the context using an average of the two estimators. Estimators may be configured to output estimates when activated. In that case, the estimators have different adaptation rates. The first adaptation rate is reacting faster to the changes in the encoded and decoded syntax element values. The second adaptation rate reacts slower, estimating more the long-term trend of the values of the syntax element. The first estimate can then be considered to have a shorter adaptation window, and the second estimate a longer one.

Encoding and decoding of image and video content is typically done in a nested tree order within a coding tree unit (CTU), starting from the top-left corner of the CTU and ending to the bottom-right corner of the CTU. As a result, when done with encoding or decoding a specific CTU, the probability estimates of the arithmetic coder are tuned for the data present in the bottom-right corner area of the CTU. When progressing to a new CTU, the encoding or decoding process continues again from the top-left corner of the new CTU and the probability estimates or context states of the arithmetic coder might not be ideal, as the processing has jumped to a different spatial location in the picture.

In an example embodiment, a discontinuity may be detected in the scanning of the coding units, and the states of an arithmetic encoder or decoder may be updated based on the location of the discontinuity in the picture. Detection of such discontinuity may be done actively or passively. For example, the update process may be activated when starting to encode or decode a new coding tree unit, as typical video and image codecs always have a scanning order discontinuity there. The update process may use either stored state variables of the arithmetic coder, or stored syntax element values from coding units close to the location where the arithmetic coding continues after the processing order discontinuity. A technical effect of example embodiments of the present disclosure may be to optimize the state of the arithmetic coder for the new spatial neighborhood.

In an example embodiment, an update process for the state variables of an arithmetic coder may be triggered when starting to encode or decode the current coding tree unit (CTU). Selecting CTU as the granularity may have multiple benefits.

Firstly, a typical video or image codec may always have a scanning order discontinuity when moving to the next CTU, as the coding of a CTU progresses from the top-left corner of a CTU to the bottom-right corner of a CTU in a nested tree order. Thus, when starting to encode or decode the next CTU, the processing jumps from the bottom-right corner of the previous CTU to the top-left corner of the next CTU. Due to that, it may be assumed that the states of the arithmetic coder may not be optimal when starting to process the next CTU.

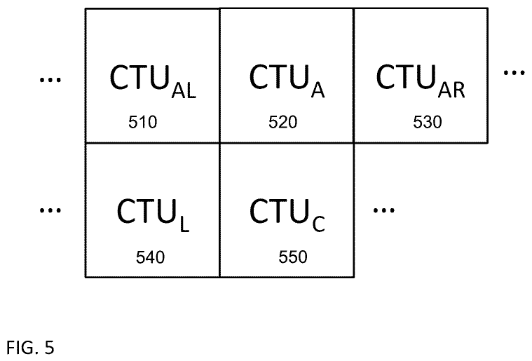

Referring now to FIG. 5, illustrated is a set of coding tree units (CTUs) that are typically encoded or decoded in a raster scan order. The current CTU is marked as CTU_{C} (550) and its above-left, above, above-right and left neighbor CTUs as CTU_{AL} (510), CTU_{A} (520), CTU_{AR} (530), and CTU_{L} (540), respectively.

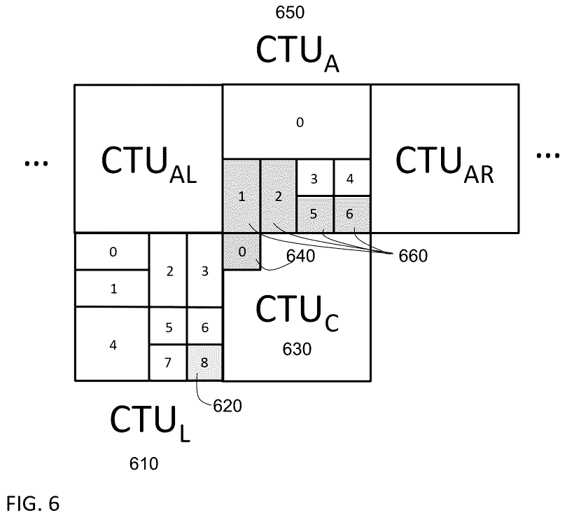

Secondly, CTUs are typically relatively large, for example of size 64×64, 128×128 or 256×256 pixels. As the spatial disconnect in the coding order is so large, it may become likely that the probability states at the end of the previous CTU may not adequately represent the probabilities in the beginning of the next CTU. Selecting a relatively large unit for adaptation may also be beneficial to keep the storage and computing requirements low for the state update process. FIG. 6 illustrates an example of a discontinuity in the scanning of the coding units. FIG. 6 illustrates examples of typical nested tree coding order of coding units for the coding tree unit above CTU_{A} and coding tree unit left CTU_{L}. Syntax elements of the bottom coding units (660) of the CTU_{A} (650) may be used to update entropy coding state parameters when entering CTU_{C} (630) instead of using the current state parameters available after encoding or decoding the left coding tree unit CTU_{L} (610) and its last coding unit 8 (620).

In the example of FIG. 6, once the bottom-right coding unit of the CTU_{L} (610), marked as 8 (620), in the coding order for that CTU is encoded or decoded, the processing may continue with the coding unit 0 (640) of the current coding tree unit CTU_{C} (630). In this case, the bottom coding units of the coding tree unit above CTU_{A} (650), for example coding unit 1, 2, 5, and/or 6 (660), may provide the arithmetic coder improved estimation of context probabilities, for example due to their relatively short distance from the coding unit 0 (640) of CTU_{C} (630).

To be able to update or tune the state variables of the arithmetic coder, some earlier state variables or syntax element values may need to be stored. In an example embodiment, at least some syntax element values of the CTU above the current CTU may be stored, and then used to update the state variables of the arithmetic coder when the encoder or decoder reaches the current CTU. Similarly, while the encoding or decoding of the current CTU progresses, at least some syntax element values of the current CTU may be stored to be used to update the arithmetic coding states when starting to encode or decode the CTU below the current CTU.

In an example embodiment, values of syntax elements belonging to the coding units (CUs) that are located at the bottom of a CTU area may be stored to a syntax element value storage. The storage may be, for example, an array, matrix, vector, list or other structure of elements that can hold a multitude of syntax element values. The syntax elements may be stored in the coding order, that is, in the order they appear in the bitstream, but naturally also other orders may be selected. To be able to operate on a pre-known amount of storage space, the maximum number of syntax elements that can be stored for a single CTU may be limited. The limit may be, for example, 512 or 1024 syntax elements, but naturally any number may be selected based on an application's needs. Such maximum number may also be selected by an encoder or other external means and signaled to a decoder.

In an example embodiment, at least some of the state variables of the arithmetic coder may be updated by reading syntax element values or bins from the syntax element value storage and feeding the values to the state update process of the arithmetic coder. The values may be read from the storage and fed to the arithmetic coding engine update process in any order. For example, the order may be determined to be the inverse of the coding order of the syntax elements; this may have the technical effect of optimizing the state values for the local neighborhood of the top-left coding unit of the current CTU, for example in the case where the syntax elements were stored in coding order for the bottom CUs of the CTU above the current CTU.

The update process of the state variables may be performed in different ways depending on the arithmetic coder used. For example, if CABAC of the H.266/VVC standard or a similar arithmetic coder is used, the update process may comprise:

$$pStateIdx = pStateIdx - ( pStateIdx ≫ shift ) + ( 1023 * binVal ≫ shift )$$

where pStateIdx is an arithmetic coder state variable describing a probability for a given context or a syntax element, binVal is a value of a syntax element read from a syntax element value storage and fed to the update process, and shift is a context dependent shift value that may be selected differently for different contexts for adjusting the adaptation speed of the probabilities for the context.

In an example embodiment, a value of a syntax element that belongs to a coding unit may be determined. In an example embodiment, a location of the coding unit inside a first coding tree unit may be determined. In an example embodiment, if the location of the coding unit fulfills predetermined criteria, the value of the syntax element may be stored to a syntax element value storage. In an example embodiment, it may be determined if the arithmetic coder is starting to encode or decode a second coding tree unit which is located adjacent to the first coding tree unit. In an example embodiment, if the arithmetic coder is starting to encode or decode the second coding tree unit, at least one syntax element value storage may be determined based on the location of the second coding tree unit. In an example embodiment, if the arithmetic coder is starting to encode or decode the second coding tree unit, at least one state variable of the arithmetic coder may be updated using at least one stored syntax element value from the syntax element value storage.

In an alternative example embodiment, the locations of the stored syntax elements or bins relating to syntax elements may be selected in different ways. For example, instead of storing syntax element values for all the coding units on the bottom border of a CTU, only a subset of those may be chosen. For example, syntax elements of only the bottom-left coding unit in a CTU may be stored, or syntax elements of coding units on the bottom left half or bottom right half of a CTU may be selected.

In an alternative example embodiment, there may be multiple syntax element storages for each CTU. For example, one syntax element storage may be used to store syntax element values of the bottom coding units in a CTU, and another syntax element storage may be used to store syntax element values of the bottom-right coding unit in a CTU. With this kind of an arrangement, the update of state variables of the arithmetic coder may include syntax elements from multiple CTUs. For example, the update may use syntax element values from both above coding tree unit CTU_{A} and above-left coding tree unit CTU_{AL}. As another example, syntax elements of the top-right coding unit of a CTU may be stored and, in that case, the update of state parameters may include those syntax elements from the left coding tree unit CTU_{L} in addition to, or instead of, syntax element values from the above coding tree unit CTU_{A}.

In an alternative example embodiment, the way of storing syntax elements may be related to the location of the target CTU where these syntax elements are used. For example, for target CTUs located on the first row of frame/slice/tile, no CTU may be available above them, so syntax element(s) from the right side of the left CTU may be stored for this target/current CTU. As another example, for target CTUS located on the first column of frame/slice/tile, no CTU may be available on the left side, so syntax element from the bottom side of the above CTU may be stored for this target/current CTU. As a result, for the CTU on the first row and the first column, syntax elements on the bottom side of the CTU may be stored for the target CTU below that CTU, and syntax elements on the right side of the CTU may be stored for the target CTU on the right side.

In an alternative example embodiment, bins may be stored for selected syntax elements. The decision criteria may be related to a number of contexts associated with that syntax element or bin. When there is a higher number of contexts for a syntax element or bin, particularly in the case that the contexts are defined based on the neighboring bins or syntax elements, there may be less need to store those context for retraining purposes. On the other hand, for the syntax element or bins that are associated with lower or only one context, there may be more need for storage and retraining according to spatial neighbors.

In an alternative example embodiment, storing of bin values or syntax element values may be done differently. For example, pairs of (context identifier, bin value) may be stored, where the context identifier may be an integer identifying each context or syntax element that has an individual context. Alternatively, a separate storage structure for each context may be used, where each bin or syntax element value may be stored in a different location based on the context. The latter example may lead to somewhat higher memory consumption, as buffers for each context may need to be allocated based on the maximum number of bin values stored for each context, but it may have the technical effect of leading to faster access to individual stored values depending on the implementation environment.

In an alternative example embodiment, the update of state variables of the arithmetic coder may be triggered in different ways. Examples of triggers for updating the state variables may include: when starting to encode or decode a new CTU; when starting to encode or decode a new CTU that is not one of the top-most CTUs within a picture, slice or tile; or when starting to encode or decode coding units with some determined characteristic(s). Examples of characteristics that may be used to determine whether to update the state variables may include determining the location of a coding unit within a CTU and making the decision based on that. For example, update may be triggered if a coding unit's top-left corner is in a specific location in the CTU, or if the coordinates of the coding unit's top-left corner are multiples of a value given as the grid size for triggering the update.

As a further example, update may be triggered if one or more of the coordinates relating to a coding unit are multiples of 32, or multiples of 64, or multiples of 128. Such grid values may be provided using bitstream signaling means, or a pre-determined value(s) may be used. The size of the grid, for example, may be selected based on the resolution of the video. For example, a larger grid size may be used for high resolution video content, for example to limit the amount of the complexity for updating the probabilities, and the memory requirement for storing the syntax elements. The size of the grid may also be selected based on the size of the CTU. For example, for CTU size 128×128, the update may be performed on a CTU basis, but for CTUs larger than that, there may be two or more updates per CTU. As an additional example, if a CTU has a size of 256×256 pixels, the update may be triggered for the coding unit in the top-left corner of the CTU, and another update may be triggered for the CU that is located at the top of the CTU and having its left border in the middle of the CTU horizontally. As another example, a second update may be triggered for the first CTU in the coding order which has horizontal coordinate larger than or equal to 128 and vertical coordinate larger than or equal to 0 within the CTU.

In an alternative example embodiment, there may be a syntax element-specific limit for how many syntax element values are stored for each syntax element. Such a limit may typically have the technical effect of providing a coding efficiency benefit, as having those limits may reduce the risk of overfitting the state variables towards the values stored in the syntax element value storage. For example if majority of the syntax element values stored in the storage relate to a single syntax element or a small subset of syntax elements, the update of state parameters relating to that syntax element or subset of syntax elements may be done so many times that the estimator that is getting updated may, in practice, “forget” its current state and become completely or almost completely a function of the values retrieved from the syntax element value storage. Thus, the number of syntax element values for a specific syntax element or context may be limited, for example, to 32, or 16, or 8, or 4 values. The limit may be the same for all the syntax elements or contexts, or it may be different for different syntax elements or contexts. The limit may also be zero for some of the syntax elements or contexts, which may have the technical effect of effectively disabling spatial adaptation of such syntax elements or contexts. The limit may be a pre-determined value or it may be decided by the encoder or by external means and indicated to a decoder using bitstream signaling. The limit may be different for different window sizes, for example it may be larger for larger window size.

To be able to update or tune state variables of the arithmetic coder, some earlier state variables or syntax element values may need to be stored. In an example embodiment, state variables relating to at least one probability estimator may be stored after the bottom-left coding unit of a CTU is encoded or decoded. When starting to encode or decode a new CTU, the stored state variables from the CTU above may be retrieved and used to update at least some of the current state variables of the arithmetic coders. Naturally, other selections may also be made. For example, some or all the state variables of the arithmetic coder may be stored after encoding or decoding a coding unit determined in some other way. For example, state variables can be stored after encoding or decoding the bottom-right coding unit of a CTU, or the top-right coding unit of a CTU, or a coding unit which is intersected by or touched by the horizontal middle of a CTU. States may also be store before encoding or decoding a determined coding unit, instead of storing states after encoding or decoding.

Updating of state variables, in an example embodiment, may be performed by averaging stored state variables with the current values of the state variables. Either all the state variables may be updated this way, or some subset of the state variables may be updated. For example, if there are two probability estimators, like in H.264/VVC standard, only the “pStateIdx0” state variables relating to the short-term estimator may be updated. In general, state variables of one or multiple estimators may be determined to be updated. Only updating the short-term estimator may typically lead to a better estimator accuracy, and improvements in coding efficiency, as that estimator may be adapting faster to changes, and thus may benefit more from the short-term estimate that is given from the local neighborhood of the coding unit that is being encoded or decoded next.

Instead of simply averaging the current and stored state variables as the update process, different combinations of the two may be used. For example, the update state parameter may be calculated as a weighted sum between the stored and current value of such parameter. Updated value(s) of a state parameter may be calculated based on more than two inputs. For example, the updated state parameter may be calculated as a weighted sum between a state parameter's current value, a value of a stored state parameter from the bottom-left coding unit of the CTU above, and a stored state parameter from the top-right coding unit of the CTU left of the current CTU.

In an example embodiment, at least some syntax element values or bins of a first coding tree unit may be used to update the state parameters of an arithmetic coder before encoding or decoding a second coding tree unit.

In an example embodiment, syntax element values or bins of bottom coding units in a first coding tree unit may be used to update the state parameters of an arithmetic coder before encoding or decoding a second coding tree unit.

In an example embodiment, at least some syntax element values or bins of a first coding tree unit may be stored and/or used to update the state parameters of an arithmetic coder before encoding or decoding a second coding tree unit.

In an example embodiment, syntax element values or bins of bottom coding units in a first coding tree unit may be stored and used to update the state parameters of an arithmetic coder before encoding or decoding a second coding tree unit.

In an example embodiment, at least one state parameter of an arithmetic coder may be updated by performing a state update process using a stored value of a syntax element, where the state update process may include calculating or setting a new value for the state parameter.

In an example embodiment, at least one state parameter of an arithmetic coder may be updated by calculating an average or a weighted average between a state parameter's current value and a value of at least one stored state parameter value.

In an example embodiment, at least one state parameter of an arithmetic coder may be updated by using stored syntax elements values in the inverse order compared to the order the syntax element values are stored in a bitstream.

The number of stored or updated syntax elements may be a function of frame/slice quantization parameter (QP), or may depend on a level of the codec. The number of actual encoded/decoded bin(s) plus the number of training bin(s) may be limited to a maximum value, which may be defined according to level of the codec.

Example embodiments of the present disclosure may be applicable to video/imaging services, applications and products.

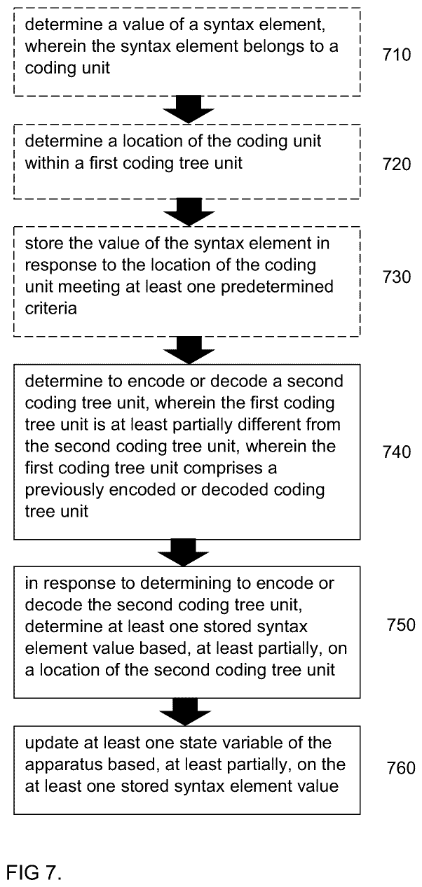

FIG. 7 illustrates the potential steps of an example method 700. The example method 700 may include: optionally, determining a value of a syntax element, wherein the syntax element belongs to a coding unit, 710; optionally, determining a location of the coding unit within a first coding tree unit, 720; optionally, storing the value of the syntax element in response to the location of the coding unit meeting at least one predetermined criteria, 730; determining to encode or decode a second coding tree unit, wherein the first coding tree unit is at least partially different from the second coding tree unit, wherein the first coding tree unit comprises a previously encoded or decoded coding tree unit, 740; in response to determining to encode or decode the second coding tree unit, determining at least one stored syntax element value based, at least partially, on a location of the second coding tree unit, 750; and updating at least one state variable of the apparatus based, at least partially, on the at least one stored syntax element value, 760. The example method 700 may be performed, for example, with a codec, an encoder, a decoder, a device configured to perform encoding, a device configured to perform decoding, a network node, a UE, an arithmetic encoder, an arithmetic decoder, etc.

In accordance with one example embodiment, an apparatus may comprise: at least one processor; and at least one memory storing instructions that, when executed by the at least one processor, cause the apparatus at least to: determine to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determine at least one stored syntax element value based, at least partially, on a location of the first coding tree unit; and update at least one state variable of the apparatus based, at least partially, on the at least one stored syntax element value.

The example apparatus may be further configured to: determine a value of a syntax element, wherein the syntax element may belong to a coding unit; determine a location of the coding unit within the second coding tree unit; and store the value of the syntax element in response to the location of the coding unit meeting at least one predetermined criteria.

The at least one stored syntax element value may comprise, at least, the value of the syntax element belonging to the coding unit within the second coding tree unit, wherein the location of the coding unit within the second coding tree unit may be proximate the location of the first coding tree unit.

The at least one predetermined criteria may comprise at least one of: the location of the coding unit being at a bottom of the second coding tree unit, the location of the coding unit being at a left-most bottom coding unit of the second coding tree unit, the location of the coding unit being a location in a bottom left half of the second coding tree unit, or the location of the coding unit being a location in a bottom right half of the second coding tree unit.

The value of the syntax element may be stored in a syntax element value storage, wherein the syntax element value storage may comprise at least one of: an array, a matrix, a vector, or a list.

The value of the syntax element may be stored based, at least partially, on at least one of: a number of stored syntax element values associated with the first coding tree, or a number of stored syntax element values associated with the syntax element.

The value of the syntax element may be stored with a context identifier.

The value of the syntax element may be stored before encoding or decoding of the coding unit.

The value of the syntax element may be stored after encoding or decoding of the coding unit.

The at least one stored syntax element value may comprise at least one of: one or more stored syntax element values of bottom coding units in a coding tree unit above the first coding tree unit, one or more stored syntax element values of bottom coding units in a coding tree unit above-left the first coding tree unit, one or more stored syntax element values of bottom coding units in the second coding tree unit, or one or more stored syntax element values of bottom-right coding units in the second coding tree unit.

The second coding tree unit may be spatially located above the first coding tree unit in a picture.

No coding tree units may be located above the first coding tree unit, wherein the second coding tree unit may be to the right of the first coding tree unit, wherein the at least one stored syntax element value may comprise one or more stored syntax element values of a right side of the second coding tree unit.

The at least one state variable may be updated based, at least partially, on at least one characteristic of the first coding tree unit, wherein the at least one characteristic of the first coding tree unit may comprise at least one of: a location of the first coding tree unit in a picture, or a location of a current coding unit in the first coding tree unit.

Updating the at least one state variable may comprise the example apparatus being further configured to: average a current value of the at least one state variable with the at least one stored syntax element value.

Updating the at least one state variable may comprise the example apparatus being further configured to: determine a weighted sum of a current value of the at least one state variable and the at least one stored syntax element value.

The at least one state variable may comprise a short-term estimator.

A maximum number of the at least one stored syntax element value may be based, at least partially, on at least one of: a frame quantization parameter, a slice quantization parameter, or a level of the apparatus.

The location of the first coding tree unit may comprise a location of a second syntax element belonging to a second coding unit within the first coding tree unit.

Determining to encode or decode the first coding tree unit may be based, at least partially, on a predetermined scanning order.

The at least one stored syntax element value may be determined based, at least partially, on an inverse of a coding order of a plurality of stored syntax element values.

The example apparatus may comprise an arithmetic encoder configured to encode the first coding tree unit.

The example apparatus may comprise an arithmetic decoder configured to decode the first coding tree unit.

In accordance with one aspect, an example method may be provided comprising: determining, with a user equipment, to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

The example method may further comprise: determining a value of a syntax element, wherein the syntax element may belong to a coding unit; determining a location of the coding unit within the second coding tree unit; and storing the value of the syntax element in response to the location of the coding unit meeting at least one predetermined criteria.

The at least one stored syntax element value may comprise, at least, the value of the syntax element belonging to the coding unit within the second coding tree unit, wherein the location of the coding unit within the second coding tree unit may be proximate the location of the first coding tree unit.

The at least one predetermined criteria may comprise at least one of: the location of the coding unit being at a bottom of the second coding tree unit, the location of the coding unit being at a left-most bottom coding unit of the second coding tree unit, the location of the coding unit being a location in a bottom left half of the second coding tree unit, or the location of the coding unit being a location in a bottom right half of the second coding tree unit.

The value of the syntax element may be stored in a syntax element value storage, wherein the syntax element value storage may comprise at least one of: an array, a matrix, a vector, or a list.

The value of the syntax element may be stored based, at least partially, on at least one of: a number of stored syntax element values associated with the first coding tree, or a number of stored syntax element values associated with the syntax element.

The at least one stored syntax element value may comprise at least one of: one or more stored syntax element values of bottom coding units in a coding tree unit above the first coding tree unit, one or more stored syntax element values of bottom coding units in a coding tree unit above-left the first coding tree unit, one or more stored syntax element values of bottom coding units in the second coding tree unit, or one or more stored syntax element values of bottom-right coding units in the second coding tree unit.

The second coding tree unit may be spatially located above the first coding tree unit in a picture.

No coding tree units may be located above the first coding tree unit, wherein the second coding tree unit may be to the right of the first coding tree unit, wherein the at least one stored syntax element value may comprise one or more stored syntax element values of a right side of the second coding tree unit.

The at least one state variable may be updated based, at least partially, on at least one characteristic of the first coding tree unit, wherein the at least one characteristic of the first coding tree unit may comprise at least one of: a location of the first coding tree unit in a picture, or a location of a current coding unit in the first coding tree unit.

The updating of the at least one state variable may comprise: averaging a current value of the at least one state variable with the at least one stored syntax element value.

The updating of the at least one state variable may comprise: determining a weighted sum of a current value of the at least one state variable and the at least one stored syntax element value.

The at least one state variable may comprise a short-term estimator.

A maximum number of the at least one stored syntax element value may be based, at least partially, on at least one of: a frame quantization parameter, a slice quantization parameter, or a level of the apparatus.

In accordance with one example embodiment, an apparatus may comprise: circuitry configured to perform: determining, with a user equipment, to encode or decode a first coding tree unit, wherein a second coding tree unit may be at least partially different from the first coding tree unit, wherein the second coding tree unit may comprise a previously encoded or decoded coding tree unit; circuitry configured to perform: in response to determining to encode or decode the first coding tree unit, determining at least one stored syntax element value based, at least partially, on a location of the first coding tree unit; and circuitry configured to perform: updating at least one state variable of the apparatus based, at least partially, on the at least one stored syntax element value.

In accordance with one example embodiment, an apparatus may comprise: processing circuitry; memory circuitry including computer program code, the memory circuitry and the computer program code configured to, with the processing circuitry, enable the apparatus to: determine to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determine at least one stored syntax element value based, at least partially, on a location of the first coding tree unit; and update at least one state variable of the apparatus based, at least partially, on the at least one stored syntax element value.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: determining to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

The means may be further configured for: determining a value of a syntax element, wherein the syntax element may belong to a coding unit; determining a location of the coding unit within the second coding tree unit; and storing the value of the syntax element in response to the location of the coding unit meeting at least one predetermined criteria.

The at least one stored syntax element value may comprise, at least, the value of the syntax element belonging to the coding unit within the second coding tree unit, wherein the location of the coding unit within the second coding tree unit may be proximate the location of the first coding tree unit.

The at least one predetermined criteria may comprise at least one of: the location of the coding unit being at a bottom of the second coding tree unit, the location of the coding unit being at a left-most bottom coding unit of the second coding tree unit, the location of the coding unit being a location in a bottom left half of the second coding tree unit, or the location of the coding unit being a location in a bottom right half of the second coding tree unit.

The value of the syntax element may be stored in a syntax element value storage, wherein the syntax element value storage may comprise at least one of: an array, a matrix, a vector, or a list.

The value of the syntax element may be stored based, at least partially, on at least one of: a number of stored syntax element values associated with the first coding tree, or a number of stored syntax element values associated with the syntax element.

The at least one stored syntax element value may comprise at least one of: one or more stored syntax element values of bottom coding units in a coding tree unit above the first coding tree unit, one or more stored syntax element values of bottom coding units in a coding tree unit above-left the first coding tree unit, one or more stored syntax element values of bottom coding units in the second coding tree unit, or one or more stored syntax element values of bottom-right coding units in the second coding tree unit.

The second coding tree unit may be spatially located above the first coding tree unit in a picture.

No coding tree units may be located above the first coding tree unit, wherein the second coding tree unit may be to the right of the first coding tree unit, wherein the at least one stored syntax element value may comprise one or more stored syntax element values of a right side of the second coding tree unit.

The at least one state variable may be updated based, at least partially, on at least one characteristic of the first coding tree unit, wherein the at least one characteristic of the first coding tree unit may comprise at least one of: a location of the first coding tree unit in a picture, or a location of a current coding unit in the first coding tree unit.

The means configured for updating the at least one state variable may be further configured for: averaging a current value of the at least one state variable with the at least one stored syntax element value.

The means configured for updating the at least one state variable may be further configured for: determining a weighted sum of a current value of the at least one state variable and the at least one stored syntax element value.

The at least one state variable may comprise a short-term estimator.

A maximum number of the at least one stored syntax element value may be based, at least partially, on at least one of: a frame quantization parameter, a slice quantization parameter, or a level of the apparatus.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: determine to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determine at least one stored syntax element value based, at least partially, on a location of the first coding tree unit; and update at least one state variable of the apparatus based, at least partially, on the at least one stored syntax element value.

In accordance with one example embodiment, a non-transitory computer-readable medium comprising program instructions stored thereon for performing at least the following: determining to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

In accordance with another example embodiment, a non-transitory program storage device readable by a machine may be provided, tangibly embodying instructions executable by the machine for performing operations, the operations comprising: determining to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

In accordance with another example embodiment, a non-transitory computer-readable medium comprising instructions that, when executed by an apparatus, cause the apparatus to perform at least the following: determining to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

A computer implemented system comprising: at least one processor and at least one non-transitory memory storing instructions that, when executed by the at least one processor, cause the system at least to perform: determining to encode or decode a first coding tree unit, wherein a second coding tree unit may be at least partially different from the first coding tree unit, wherein the second coding tree unit may comprise a previously encoded or decoded coding tree unit; in response to determining to encode or decode the first coding tree unit, determining at least one stored syntax element value based, at least partially, on a location of the first coding tree unit; and updating at least one state variable of the apparatus based, at least partially, on the at least one stored syntax element value.

A computer implemented system comprising: means for determining to encode or decode a first coding tree unit, wherein a second coding tree unit may be at least partially different from the first coding tree unit, wherein the second coding tree unit may comprise a previously encoded or decoded coding tree unit; means for in response to determining to encode or decode the first coding tree unit, determining at least one stored syntax element value based, at least partially, on a location of the first coding tree unit; and means for updating at least one state variable of the apparatus based, at least partially, on the at least one stored syntax element value.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising:
at least one processor; and
at least one non-transitory memory storing instructions that, when executed by the at least one processor, cause the apparatus at least to:
determine to encode or decode a first coding tree unit, wherein a second coding tree unit is at least partially different from the first coding tree unit, wherein the second coding tree unit comprises a previously encoded or decoded coding tree unit;
in response to determining to encode or decode the first coding tree unit, determine at least one stored syntax element value based, at least partially, on a location of the first coding tree unit; and
update at least one state variable of the apparatus based, at least partially, on the at least one stored syntax element value.

2. The apparatus of claim 1, wherein the at least one memory stores instructions that, when executed by the at least one processor, cause the apparatus to:
determine a value of a syntax element, wherein the syntax element belongs to a coding unit;
determine a location of the coding unit within the second coding tree unit; and
store the value of the syntax element in response to the location of the coding unit meeting at least one predetermined criteria.

3. The apparatus of claim 2, wherein the at least one stored syntax element value comprises, at least, the value of the syntax element belonging to the coding unit within the second coding tree unit, wherein the location of the coding unit within the second coding tree unit is proximate the location of the first coding tree unit.

4. The apparatus of claim 2, wherein the at least one predetermined criteria comprises at least one of:
the location of the coding unit being at a bottom of the second coding tree unit,
the location of the coding unit being at a left-most bottom coding unit of the second coding tree unit,
the location of the coding unit being a location in a bottom left half of the second coding tree unit, or
the location of the coding unit being a location in a bottom right half of the second coding tree unit.

5. The apparatus of claim 2, wherein the value of the syntax element is stored in a syntax element value storage, wherein the syntax element value storage comprises at least one of:
an array,
a matrix,
a vector, or
a list.

6. The apparatus of claim 2, wherein the value of the syntax element is stored based, at least partially, on at least one of:
a number of stored syntax element values associated with the first coding tree, or
a number of stored syntax element values associated with the syntax element.

7. The apparatus of claim 1, wherein the at least one stored syntax element value comprises at least one of:
one or more stored syntax element values of bottom coding units in a coding tree unit above the first coding tree unit,
one or more stored syntax element values of bottom coding units in a coding tree unit above-left the first coding tree unit,
one or more stored syntax element values of bottom coding units in the second coding tree unit, or
one or more stored syntax element values of bottom-right coding units in the second coding tree unit.

8. The apparatus of claim 7, wherein the second coding tree unit is spatially located above the first coding tree unit in a picture.

9. The apparatus of claim 1, wherein no coding tree units are located above the first coding tree unit, wherein the second coding tree unit is to the right of the first coding tree unit, wherein the at least one stored syntax element value comprises one or more stored syntax element values of a right side of the second coding tree unit.

10. The apparatus of claim 1, wherein the at least one state variable is updated based, at least partially, on at least one characteristic of the first coding tree unit, wherein the at least one characteristic of the first coding tree unit comprises at least one of:
a location of the first coding tree unit in a picture, or
a location of a current coding unit in the first coding tree unit.

11. The apparatus of claim 1, wherein updating the at least one state variable comprises the at least one memory stores instructions that, when executed by the at least one processor, cause the apparatus to:
average a current value of the at least one state variable with the at least one stored syntax element value.

12. The apparatus of claim 1, wherein updating the at least one state variable comprises the at least one memory stores instructions that, when executed by the at least one processor, cause the apparatus to:
determine a weighted sum of a current value of the at least one state variable and the at least one stored syntax element value.

13. The apparatus of claim 1, wherein the at least one state variable comprises a short-term estimator.

14. The apparatus of claim 1, wherein a maximum number of the at least one stored syntax element value is based, at least partially, on at least one of:
a frame quantization parameter,
a slice quantization parameter, or
a level of the apparatus.

15. A method comprising:
determining, with a user equipment, to encode or decode a first coding tree unit, wherein a second coding tree unit is at least partially different from the first coding tree unit, wherein the second coding tree unit comprises a previously encoded or decoded coding tree unit;
in response to determining to encode or decode the first coding tree unit, determining at least one stored syntax element value based, at least partially, on a location of the first coding tree unit; and
updating at least one state variable of the apparatus based, at least partially, on the at least one stored syntax element value.

16. The method of claim 15, further comprising:
determining a value of a syntax element, wherein the syntax element belongs to a coding unit;
determining a location of the coding unit within the second coding tree unit; and
storing the value of the syntax element in response to the location of the coding unit meeting at least one predetermined criteria.

17. The method of claim 16, wherein the at least one stored syntax element value comprises, at least, the value of the syntax element belonging to the coding unit within the second coding tree unit, wherein the location of the coding unit within the second coding tree unit is proximate the location of the first coding tree unit.

18. The method of claim 16, wherein the at least one predetermined criteria comprises at least one of:
the location of the coding unit being at a bottom of the second coding tree unit,
the location of the coding unit being at a left-most bottom coding unit of the second coding tree unit,
the location of the coding unit being a location in a bottom left half of the second coding tree unit, or
the location of the coding unit being a location in a bottom right half of the second coding tree unit.

19. The method of claim 15, wherein the at least one stored syntax element value comprises at least one of:
one or more stored syntax element values of bottom coding units in a coding tree unit above the first coding tree unit,
one or more stored syntax element values of bottom coding units in a coding tree unit above-left the first coding tree unit,
one or more stored syntax element values of bottom coding units in the second coding tree unit, or
one or more stored syntax element values of bottom-right coding units in the second coding tree unit.

20. A non-transitory computer-readable medium comprising program instructions stored thereon for performing at least the following:
determining to encode or decode a first coding tree unit, wherein a second coding tree unit is at least partially different from the first coding tree unit, wherein the second coding tree unit comprises a previously encoded or decoded coding tree unit;
in response to determining to encode or decode the first coding tree unit, determining at least one stored syntax element value based, at least partially, on a location of the first coding tree unit; and
updating at least one state variable of the apparatus based, at least partially, on the at least one stored syntax element value.
